(19) United States
(12) Patent Application Publication
(10) Pub. No.: US 2024/0086095 A1
(43) Pub. Date: Mar. 14, 2024

(54) DATA LAYOUT OPTIMIZATION FOR OBJECT-ORIENTED STORAGE ENGINE

(71) Applicant: Alibaba Group Holding Limited, Grand Cayman (KY)

(72) Inventors: Peng Xu, Milpitas, CA (US); Yikang Xu, Redmond, WA (US); Yu Du, Hangzhou (CN); Rui Wang, Redmond, WA (US)

(21) Appl. No.: 18/274,295

(22) PCT Filed: Feb. 7, 2021
(86) PCT No.: PCT/CN2021/075779

§ 371 Date: Jul. 26, 2023

(51) Int. Cl. G06F 3/06

(52) U.S. Cl. CPC G06F 3/0638; G06F 3/0611; G06F 3/0652; G06F 3/067

(57) ABSTRACT

A storage engine may be configured to receive data including a plurality of records from a client device, and generate a plurality of record headers for the plurality of records. The storage engine may then transfer a group of record headers of the plurality of record headers to a storage device to cause the storage device to store the group of record headers consecutively in a data sector of the storage device, and further transfer a subset of payload data of one or more records associated with the group of record headers to the storage device to cause the storage device to store the one or more records after the group of record headers in the data sector of the storage device.

### BACKGROUND

In existing object-oriented storage systems, when an object including a plurality of records needs to be stored in a storage device (such as an append-only storage device) in a cloud computing system, a storage engine is used to write the object into the storage device. In each write operation of the object, the storage engine may write a record of the plurality of records of the object into the storage device. In order to manage data of the record (also called payload data of the record), the storage engine needs to create a record header. The storage engine needs to write the record header of the record into the storage device first, and then write the payload data of the record at a storage location just after the end (i.e., the last bit of data) of the record header.

In other words, in order to write all the records of the object into the storage device, the storage engine needs to perform multiple write operations for the plurality of records, and alternately write a respective record header and a respective piece of payload data of each record of the plurality of records of the object into the storage device until all the record headers and all pieces of the payload data of the plurality of records of the object are written into the storage device. Such repeatedly alternate operations of writing record headers and payload data of records of an object into a storage device not only lead to additional processing time and power of a storage engine for switching and fetching the record headers and the payload data of the records of the object from a memory of the storage engine for writing, but also cause a prolonged occupancy of a communication channel between the storage engine and the storage device, thus reducing the storage and processing efficiency of the storage engine.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 illustrates an example data layout and related entry list for appending or writing records of an object.

FIG. 2 illustrates an example environment in which a storage system may be used.

FIG. 3 illustrates the example storage system in more detail.

FIG. 4 illustrates another example data layout and related entry list for appending or writing records of an object.

FIG. 5 illustrates a first example data writing method.

FIG. 6 illustrates a second example data writing method.

FIG. 7 illustrates an example data reading method.

### DETAILED DESCRIPTION

### Overview

As described above, in existing technologies, when writing records of an object into a storage device, a storage engine needs to perform multiple write operations for the records, and alternately write a respective record header and a respective piece of payload data of each record of the records of the object into the storage device until all the record headers and all pieces of payload data of the records of the object are written into the storage device. Such repeatedly alternate operations of writing record headers and payload data of records of an object into a storage device not only lead to additional processing time and power of a storage engine for switching and fetching the record headers and the payload data of the records of the object from a memory of the storage engine for writing, but also cause an prolonged occupancy of a communication channel between the storage engine and the storage device, thus reducing the storage and processing efficiency of the storage engine.

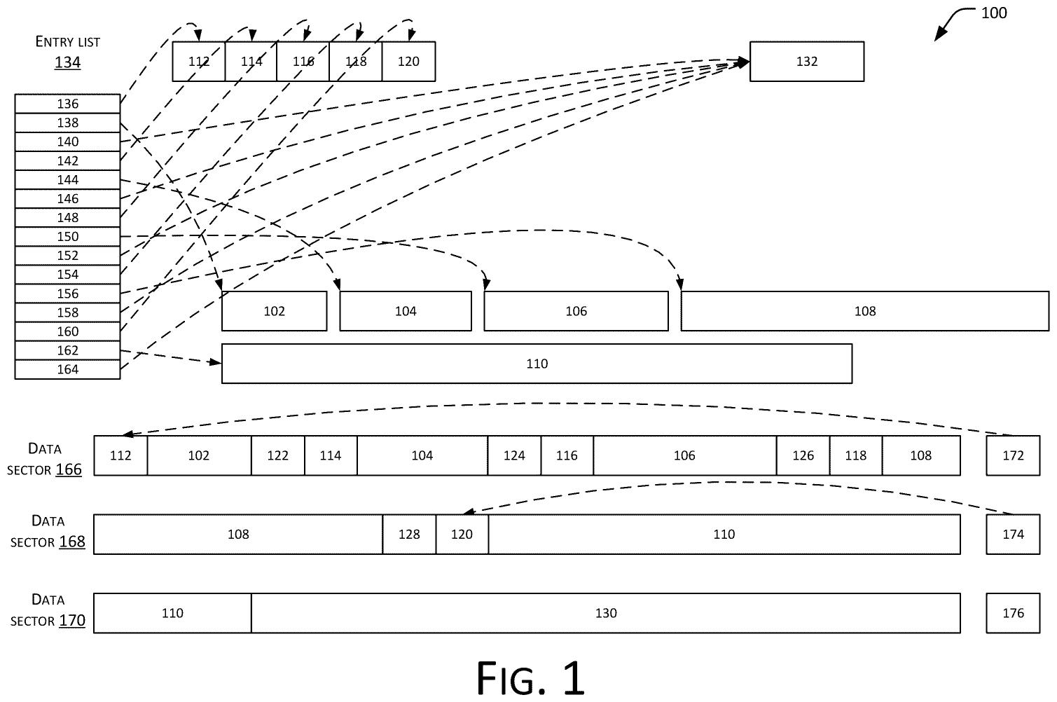

FIG. 1 shows an example data layout and related entry list for appending or writing records of an object. An arrow in the figure represents an indicative or pointing relationship between (or from) an object at the tail of the arrow and (or to) another object at the head of the arrow. In this example, a data layout of a record that is or is to be written in a storage device may include a record header created for managing payload data (such as valid data) of the record, the payload data of the record, and padding data that is used for ensuring that the record is aligned to a cache-line boundary when the record header is read from the storage device. During a process of writing or storing the record from a memory associated with a storage engine to the storage device, these three data segments (i.e., the record header, the payload data, and the padding data) are first needed to be grouped or linked together. In order to group or link these three data segments, three individual index entries are needed to be set up in an entry list (or called as a scatter-gather list) in the memory of the storage engine, and are made to be associated with the data segments (i.e., one for each of these three data segments). In this case, when the record is written or stored from the memory of storage engine to the storage device, the storage engine requires three individual data accesses to the entry list to retrieve the three individual index entries for the data segments (i.e., the record header, the payload data, and the padding data) of the record, and three individual data accesses to the memory of the storage engine to obtain the data segments of the record for transferring to the storage device.

Since an entry list that groups or links respective data segments of each record is needed to be set up, a data access to each data segment may be a random access if the respective data segments of each record are scattered in the memory of the storage engine. Furthermore, as a record header may not be at the beginning (i.e., a start offset as zero) of a data sector of the storage device, a pointer is needed to indicate or point to a first record header in the data sector in order to allow the storage engine to locate the first record header and search through one or more record headers in the data sectors until a requested record is found during a read process of obtaining the requested record. Moreover, since record headers are not consecutive in the data sector, data padding is needed so that each record header will start at a cache-line boundary to optimize cache accesses during the read process.

For example, in an example data layout and related entry list 100 as shown in FIG. 1, 5 records, namely, records 102, 104, 106, 108, and 110, are to be written, with respective data sizes as 128 bytes, 512 bytes, 1024 bytes, 3072 bytes, and 3148 bytes. Furthermore, 5 record headers, namely, record headers 112, 114, 116, 118, and 120, are created respectively for the records 102-110. Moreover, five pieces of padding data, namely, padding data 122, 124, 126, 128, and 130 are set for the records 102, 104, 106, 108, and 110 respectively, and come from a padding data buffer 132. In this example, an entry list 134 stores 15 index entries, namely, index entries 136, 138, 140, 142, 144, 145, 148, 150, 152, 154, 156, 158, 160, 162, and 164, that point to respective data segments (i.e., a record header, payload data, and padding data) of the records 102, 104, 106, 108, and 110. After the records 102, 104, 106, 108, and 110 are successfully written into 3 data sectors 166, 168, and 170 of the storage device, pointers are added into respective metadata areas 172, 174, and 176 of the data sectors 166-170 to indicate starting positions of first records in the data sectors 166, 168, and 170 (if any).

This disclosure describes an example storage system. In implementations, the storage system may include a storage engine and one or more storage devices. In implementations, the storage engine may receive data of an object from a client device through a network. In implementations, the object may include a plurality of records. Based on sizes of respective payload data of the plurality of records, the storage engine may determine how and where to write the respective payload data of the plurality of records into a storage device, such as how many data sectors are needed for writing or storing the respective payload data of the plurality of records. In implementations, the storage engine may generate a plurality of record headers that are used for managing the plurality of records (or corresponding pieces of payload data of the plurality of records. In implementations, a record header may include data size information, error check information, etc., of a corresponding record (or a corresponding piece of payload data of the record).

In implementations, the storage engine may generate an entry list (such as a scatter-gather list), and generate or add a plurality of index entries that store or point to respective storage locations (such as storage addresses) of the plurality of records and the plurality of record headers in a memory associated with the storage engine. In implementations, the storage engine may assign an index entry to a corresponding portion (which may be an entire portion or a partial portion) of payload data of a record of the plurality of records, and an index entry to a group of one or more record headers associated with one or more records of the plurality of records.

In implementations, the storage engine may select multiple record headers that are associated with multiple records from among the plurality of record headers, and send the multiple record headers to a storage device (for example, through a single data transfer from a memory of the storage engine to the storage device), to cause the storage device to consecutively store or write the multiple record headers as a group or as a whole, for example, at the beginning part of a data sector of the storage device. The storage engine may then send at least a portion of payload data of the multiple records that are associated with the multiple record headers to the storage device to cause the storage device to write or store this portion of the payload data of the multiple records at a storage location that is located immediately after the multiple record headers in the data sector of the storage device. In implementations, the storage engine or the storage device may further record a start offset (with respect to a start address of the data sector) of a first record of the multiple records that are stored in the data sector in a special area (which may be called as a metadata area or an out-of-band (OOB) area) of the data sector. In implementations, the metadata area or the OOB area of the data sector may be located at the end of the data sector.

In implementations, if there still remain some record headers and payload data of some records of the object that have not been written or stored into the storage device, the storage engine may repeat the above operations for writing these remaining record headers and the payload data of these records into additional one or more data sectors (e.g., data sectors that are adjacent to or immediately follows after the above data sector), until the plurality of record headers and the plurality of records are successfully or completely written or stored in the storage device.

As described above, the storage system does not need to write or store payload data of a record in a storage location that is adjacent to and immediately follows after a record header of the record. Without such constraint or limitation, the storage engine of the storage system can write record headers of multiple records as a group or as a whole to a data sector of a storage device through a single data transfer or a single data access to the storage device, and store the record headers consecutively in the data sector, for example, at the beginning part of the data sector. The storage engine may then write payload data of the multiple records to the data sector of the storage device. This not only reduces the processing time and power of the storage engine for switching and fetching record headers and payload data of records of an object from a memory of the storage engine for data transmission and writing, but also avoid or reduce the occupancy of a communication channel between the storage engine and the storage device due to a fewer number of data transfers therebetween, thus improving the storage and processing efficiency of the storage engine.

Furthermore, the storage engine may require or generate fewer index entries because, for example, a single index entry in the scatter-gather list may correspond to a group of record headers, rather than a single record header. Moreover, since padding data may not be needed at the end of each logical block (except at the end of a data sector storing the last record of the plurality of records), the utilization or usage rate of storage spaces of a block storage device (such as a solid state device, etc.) is increased, and the number of data sectors that are used for writing or storing the plurality of records may be reduced, as compared to existing storage methods. Also, as the storage system may store multiple record headers consecutively in a data sector of a storage device, these record headers can be retrieved or obtained as a group at one time during a read process, thus fully utilizing the cache-line capability of one or more processors associated with the storage engine.

In implementations, functions described herein to be performed by the storage system may be performed by multiple separate services or units. Moreover, although in the examples described herein, the storage system may be implemented as a combination of software and hardware implemented in an individual entity or device, in other examples, the storage system may be implemented and distributed as services provided in one or more computing devices over a network and/or in a cloud computing architecture.

The application describes multiple and varied embodiments and implementations. The following section describes an example framework that is suitable for practicing various implementations. Next, the application describes example systems, devices, and processes for implementing a storage system.

### Example Environment

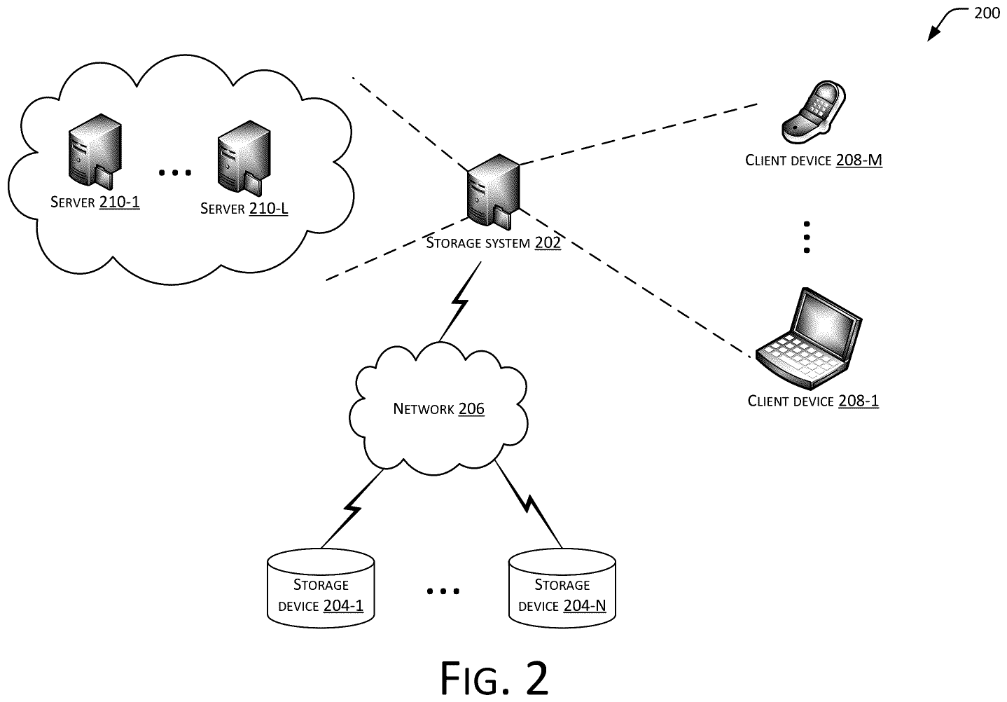

FIG. 2 illustrates an example environment 200 usable to implement a storage system. The environment 200 may include a storage system 202, and one or more storage devices 204-1, . . . , 204-N (which are collectively called as storage devices 204), where N is an integer greater than or equal to one. The storage system 202 and the plurality of storage devices 204 may communicate data with one another via a network 206. In this example, the one or more storage devices 204 are said to be included in the storage system 202. In other instances, the one or more storage devices 204 may be peripheral and accessible to the storage system 202.

In this example, the storage system 202 is described to be an individual entity or device. In other instances, the storage system 202 may be located or included in one or more client devices 208-1, . . . , 208-M (which are collectively called as client devices 208), and/or one or more servers 210-1, . . . , 210-L (which are collectively called as servers 210), where M and L are integers greater than or equal to one. In implementations, the storage system 202 may be included in a data center or cloud computing infrastructure including a plurality of servers 210.

In implementations, each of the one or more client devices 208 and the one or more servers 210 may be implemented as any of a variety of computing devices, but not limited to, a desktop computer, a notebook or portable computer, a handheld device, a netbook, an Internet appliance, a tablet or slate computer, a mobile device (e.g., a mobile phone, a personal digital assistant, a smart phone, etc.), a server computer, etc., or a combination thereof.

In implementations, each of the one or more storage devices 204 may be implemented as any of a variety of devices having memory or storage capabilities, but not limited to, a block storage device, a solid state device (SSD), a NUMA (Non-Uniform Memory Access) device, a NVMe (Non-Volatile Memory Express) device, etc.

The network 206 may be a data communication network including one or more data communication lines or channels that connect the storage system 202 (such as a memory of the storage system 202) and the one or more storage devices 204 through wireless and/or wired connections. Examples of wired connections may include an electrical carrier connection (for example, a communication cable, a computer or communication bus such as a serial bus, a PCIe bus or lane, etc.), an optical carrier connection (such as an optical fiber connection, etc.). Wireless connections may include, for example, a WiFi connection, other radio frequency connections (e.g., Bluetooth®, etc.), etc.

In implementations, the storage system 202 may receive data of an object including a plurality of records from a client device (such as the client device 208-1) through the network 206. After determining one or more data sectors of a storage device (such as the storage device 204-1) to which respective pieces of payload data of the plurality of records are written, the storage engine may generate a plurality of record headers for the plurality of records, and write the plurality of record headers and the respective pieces of payload data of the plurality of records into the one or more data sectors according to the data writing method described herein.

### Example Storage System

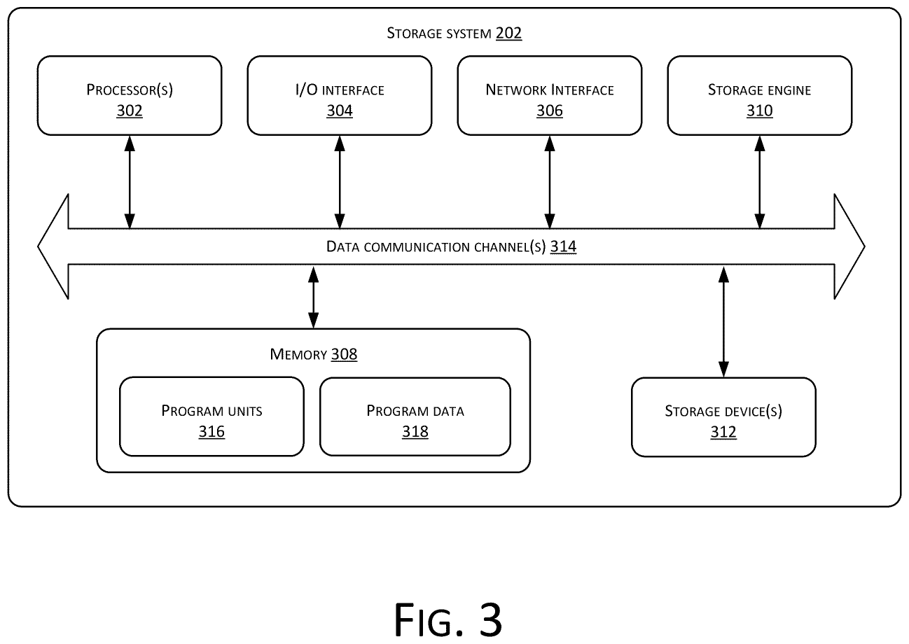

FIG. 3 illustrates the storage system 202 in more detail. In implementations, the storage system 202 may include, but is not limited to, one or more processors 302, an input/output (I/O) interface 304, and/or a network interface 306, and memory 308. Additionally, the storage system 202 may further include a storage engine 310, one or more storage devices 312 (such as the one or more storage devices 204), and one or more data communication channels 314. In implementations, the storage engine 310 may include at least one processor (such as the processor 302) and memory (such as the memory 308). In implementations,

In implementations, some of the functions of the storage system 202 may be implemented using hardware, for example, an ASIC (i.e., Application-Specific Integrated Circuit), a FPGA (i.e., Field-Programmable Gate Array), and/or other hardware. In implementations, the storage system 202 may include one or more computing devices such as the computing devices 208 as shown in FIG. 1, or may be included in one or more computing devices.

In implementations, the processors 302 may be configured to execute instructions that are stored in the memory 308, and/or received from the I/O interface 304, and/or the network interface 306. In implementations, the processors 302 may be implemented as one or more hardware processors including, for example, a microprocessor, an application-specific instruction-set processor, a physics processing unit (PPU), a central processing unit (CPU), a graphics processing unit, a digital signal processor, a tensor processing unit, etc. Additionally or alternatively, the functionality described herein can be performed, at least in part, by one or more hardware logic components. For example, and without limitation, illustrative types of hardware logic components that can be used include field-programmable gate arrays (FPGAs), application-specific integrated circuits (ASICs), application-specific standard products (ASSPs), system-on-a-chip systems (SOCs), complex programmable logic devices (CPLDs), etc.

The memory 308 may include computer readable media (or processor readable media) in a form of volatile memory, such as Random Access Memory (RAM) and/or non-volatile memory, such as read only memory (ROM) or flash RAM. The memory 308 is an example of computer readable media (or processor readable media).

The computer readable media (or processor readable media) may include a volatile or non-volatile type, a removable or non-removable media, which may achieve storage of information using any method or technology. The information may include a computer readable instruction (or a processor readable instruction), a data structure, a program module or other data. Examples of computer readable media (or processor readable media) include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media (or processor readable media) does not include any transitory media, such as modulated data signals and carrier waves.

In implementations, the one or more data communication channels 314 may include at least one or more data communication lines or channels that connect the storage system 202 (such as the memory 308 of the storage system 202) and the one or more storage devices 312 through wireless and/or wired connections. Examples of wired connections may include an electrical carrier connection (for example, a communication cable, a computer or communication bus such as a serial bus, a PCIe bus or lane, etc.), an optical carrier connection (such as an optical fiber connection, etc.). Wireless connections may include, for example, a WiFi connection, other radio frequency connections (e.g., Bluetooth®, etc.), etc.

Although in this example, only hardware components are described in the storage system 202, in other instances, the storage system 202 may further include other hardware components and/or other software components such as program units 316 to execute instructions stored in the memory 308 for performing various operations, and program data 318 that stores application data and data of tasks processed by the storage system 202. In this example, the one or more storage devices 312 are described to be included in the storage system 202. In other instances, the one or more storage devices 312 may be associated with the storage system 202. For example, the one or more storage devices 312 may be peripheral and accessible to one or more components of the storage system 202 (such as the storage engine 310). By way of example and not limitation, the storage engine 310 may communicate data with the one or more storage devices 312 through one or more data communication channels and/or one or more data networks.

### Example Methods

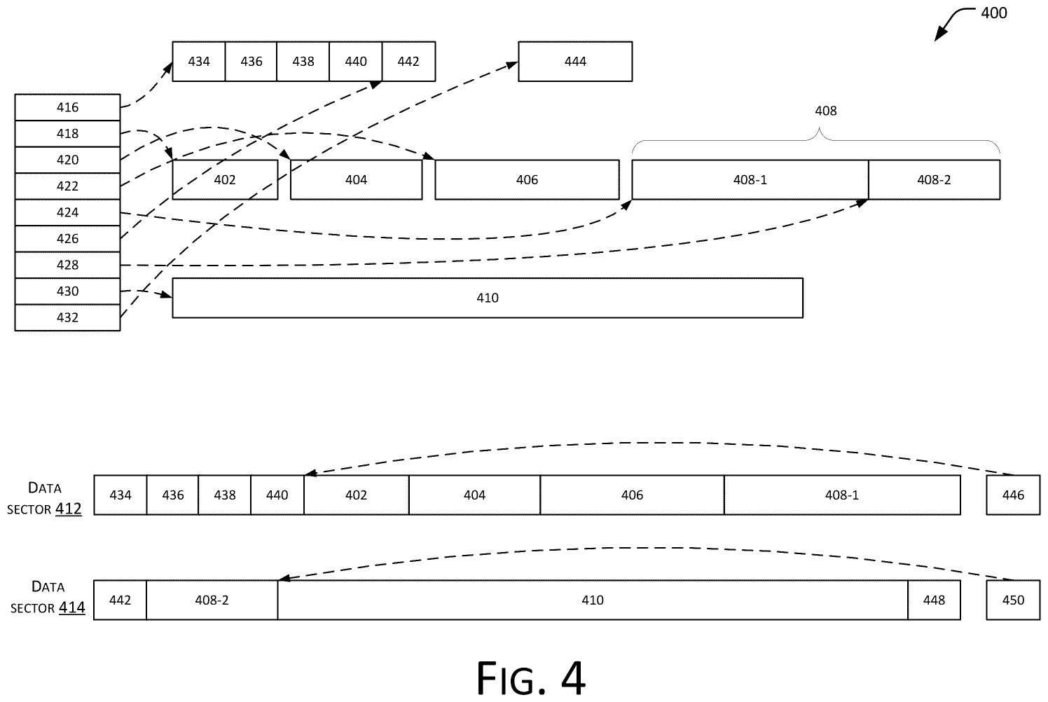

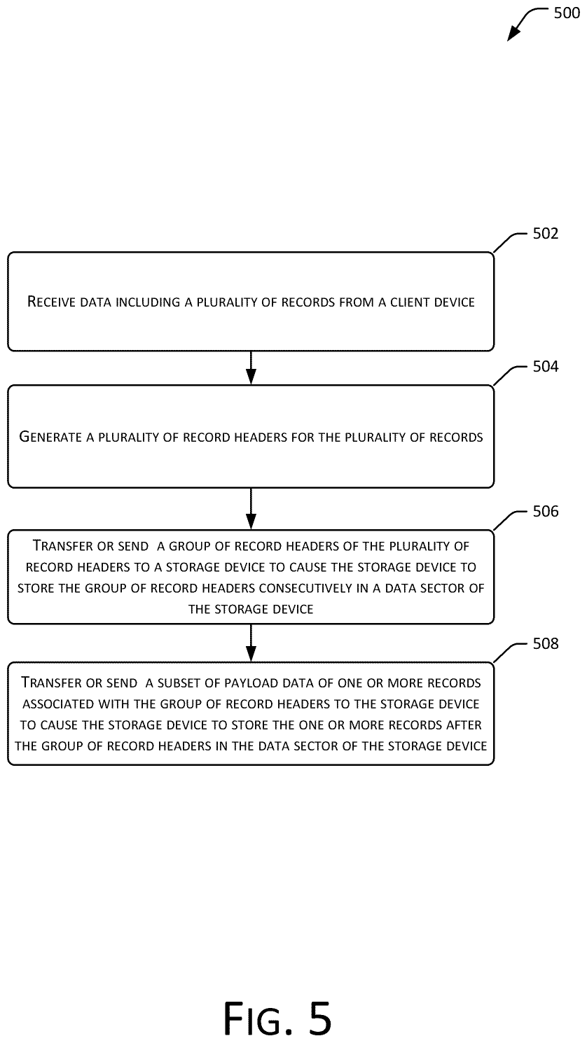

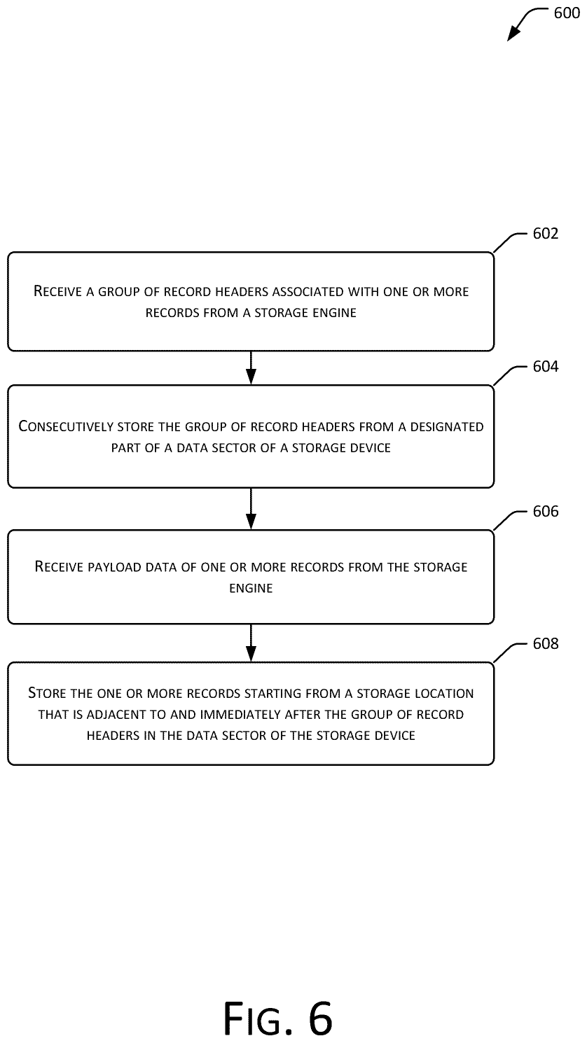

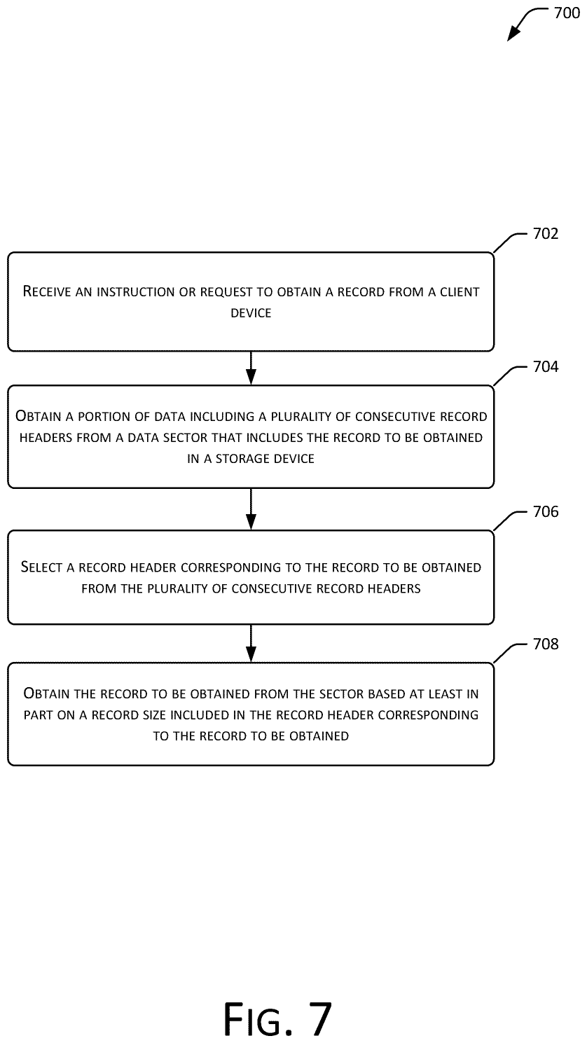

FIG. 4 illustrates a schematic diagram depicting another example data layout and related entry list for appending or writing records of an object. An arrow in the figure represents an indicative or pointing relationship between (or from) an object at the tail of the arrow and (or to) another object at the head of the arrow. FIG. 5 illustrates a schematic diagram depicting a first example data writing method. FIG. 6 illustrates a schematic diagram depicting a second example data writing method. FIG. 7 illustrates a schematic diagram depicting an example data reading method. The methods of FIGS. 5-7 may, but need not, be implemented in the environment of FIG. 1, and using the system of FIG. 2 and the data layout and related entry list of FIG. 4. For ease of explanation, methods 500-700 are described with reference to FIGS. 1, 2, and 4. However, the methods 500-700 may alternatively be implemented in other environments and/or using other systems.

The methods 500-700 are described in the general context of computer-executable instructions. Generally, computer-executable instructions can include routines, programs, objects, components, data structures, procedures, modules, functions, and the like that perform particular functions or implement particular abstract data types. Furthermore, each of the example methods are illustrated as a collection of blocks in a logical flow graph representing a sequence of operations that can be implemented in hardware, software, firmware, or a combination thereof. The order in which the method is described is not intended to be construed as a limitation, and any number of the described method blocks can be combined in any order to implement the method, or alternate methods. Additionally, individual blocks may be omitted from the method without departing from the spirit and scope of the subject matter described herein. In the context of software, the blocks represent computer instructions that, when executed by one or more processors, perform the recited operations. In the context of hardware, some or all of the blocks may represent application specific integrated circuits (ASICs) or other physical components that perform the recited operations.

Referring back to FIG. 5, at block 502, the storage engine 310 may receive data including a plurality of records from a client device.

In implementations, the storage system 202 or the storage engine 310 may receive data to be stored or written from a client device (such as the client device 208 in this example) via the network 206. In implementations, the data to be stored may include a plurality of records of an object. In implementations, the object may include, but is not limited to, a database object, a file object, etc. In implementations, each record of the plurality of records may include a respective piece of payload data of a same or different data size.

At block 504, the storage engine 310 may generate a plurality of record headers for the plurality of records.

In implementations, after receiving the data from the client device, the storage engine 310 may perform a number of operations prior to writing or storing the data in a storage device. In implementations, the storage engine 310 may select or determine a storage device in which the data is to be written or stored. By way of example and not limitation, the storage engine 310 may select or determine a storage device in which the data is to be written or stored randomly or according to a predefined heuristic strategy, such as a predefined load balancing strategy.

Additionally, in implementations, the storage engine 310 may determine one or more data sectors of the selected storage device to which the data is to be written or stored. In implementations, the storage engine 310 may determine how many data sectors are used for writing or storing the plurality of records, based on respective data sizes of the plurality of records included in the data and a memory or storage size of each data sector of the storage device 204. For example, in an example data layout and related entry list 400 of FIG. 4, if the data is said to include 5 records (a record 402 with a size of 128 bytes, a record 404 with a size of 512 bytes, a record 406 with a size of 2024 bytes, a record 408 with a size of 3072 bytes, and a record 410 with a size of 3148 bytes) the storage engine 310 may determine that 2 data sectors (i.e., a data sector 412 and a data sector 414 as shown in FIG. 4) are needed to write or store the data, with each data sector being assumed to have a memory size of 4096 bytes or 4 kilobytes in this example. Apparently, if a memory size of a data sector is different and/or a total size of records included in data to be written or stored is different, the number of data sectors used for writing or storing the data will be different.

Additionally, in implementations, the storage engine 310 may determine respective pieces or portions of payload data of one or more records of the plurality of records that are to be written or stored in a data sector of the one or more data sectors, based on the respective data sizes of the plurality of records, the memory size of the data sector of the storage device 204, and data sizes of one or more record headers for the respective pieces of payload data of the one or more records.

For example, in the example as shown FIG. 4, if a memory size of a data sector is 4 kilobytes and a data size of a record header is 56 bytes, an entire portion of payload data of the record 402 (i.e., 128 bytes in size), an entire portion of payload data of the record 404 (i.e., 512 bytes in size), an entire portion of payload data of the record 406 (i.e., 2024 bytes in size), a partial portion 408-1 of payload data of the record 408 (i.e., 2308 bytes) are to be written or stored in the data sector 412, and a remaining portion 408-2 of payload data of the record 408 (i.e., 864 bytes) and an entire portion of payload data of the record 410 (i.e., 3148 bytes in size) are to be written or stored in the data sector 414.

Additionally, in implementations, the storage engine 310 may create or generate a plurality of record headers, with one record header for each of the plurality of records included in the data. In implementations, the storage engine 310 may temporarily store the plurality of record headers in the memory associated with the storage engine 310 before the plurality of record headers are sent to the storage device 204 and are successfully stored in the storage device 204. In implementations, the storage engine 310 may store the plurality of record headers in the memory associated with the storage engine 310 consecutively or together to facilitate retrieval and grouping of multiple record headers at one time. In implementations, a record header for a record may include at least one or more data fields including, but are not limited to, information of a data size of the record, etc. Additionally, in some instances, the one or more data fields of the record header may further include error check information (such as information of a redundancy check code, etc.), a flag to be used by the storage device 204 or the storage engine 310 for indicating whether the record is deleted, etc.

Additionally, in implementations, the storage engine 310 may further create or set up an entry list (or called as a scatter-gather list) that includes a plurality of index entries for pointing to the plurality of records and at least some of the plurality of record headers, and store the entry list in a memory (such as the memory 308) associated with the storage engine 310. In implementations, the storage engine 310 may create or set up the entry list in any data structure, such as a linked list, an array, etc., that may facilitate searching or retrieving an index entry from the entry list, and grouping related data segments (such as record headers, and records, padding data, etc.) using the entry list. In implementations, the storage engine 310 may create or generate an index entry, such as a single entry, for one or more record headers that are to be written or stored in a data sector of the one or more data sectors, and create or generate additional index entries for respective portions (which may be an entire portion or a partial portion) of payload data of corresponding one or more records that are to be written or stored in the data sector.

For example, in the example as shown FIG. 4, the storage engine 310 may create or generate a plurality of index entries 416, 418, 420, 422, 424, 426, 428, 430, and 432. In this example, the storage engine 310 may assign the index entry 416 to store or point to a start storage location (such as start storage address, for example) of a group of record headers (record headers 434, 436, 438, and 440) that are currently stored in a memory (such as the memory 308) associated with the storage engine 310 and are awaiting for writing or storing by the storage engine 310. In this example, the record headers 434, 436, 438, and 440 of the group are associated with corresponding portions of payload data of the records 402, 404, 406, and 408. In this example, since only a partial portion 408-1 of payload data of the record 408 is written or stored in the data sector 412 due to a size limitation of the data sector 412, the record header 440 is associated with such partial portion 408-1 of payload data of the record 408. Additionally, the storage engine 310 may assign the index entries 418, 420, 422, and 424 to store or point to respective start storage locations of the corresponding portions of payload data of the records 402, 404, 406, and 408 that are currently stored in the memory associated with the storage engine 310. Additionally, the storage engine 310 may assign the index entry 426 to store or point to a start storage location of the record header 442 that is currently stored in the memory associated with the storage engine 310, the record header 442 being associated with a corresponding portion of payload data of the record 410 that is to be written or stored in the data sector 414. Additionally, the storage engine 310 may assign index entries 428 and 430 to store or point to respective start storage locations of corresponding portions of payload data of the records 408 and 410 that are currently stored in the memory associated with the storage engine 310 (i.e., a remaining portion 408-2 of payload data of the record 408 and an entire portion of payload data of the record 410 in this example). In this example, the storage engine 310 may further assign the index entry 432 to store or point to a start storage location of a padding data buffer 444 configured to provide padding data that is needed at the end of a data sector for the purpose of logical block alignment (i.e., alignment of data storage in logical blocks of a block storage device such as solid state devices).

At block 506, the storage engine 310 may transfer or send a group of record headers of the plurality of record headers to a storage device to cause the storage device to store the group of record headers consecutively in a data sector of the storage device.

In implementations, after performing the one or more operations as described above, the storage engine 310 may attempt to start writing or storing the payload data of the plurality of records and the plurality of record headers to the selected storage device. In implementations, the storage engine 310 may read the entry list to retrieve or obtain an index entry for a group of record headers to be written or stored into a data sector of the storage device 204. In implementations, the group of record headers may include one or more record headers corresponding to respective portions of payload data of one or more records of the plurality of records. For example, in the example as shown in FIG. 4, the index entry 416 stores or points to the storage location of the group of record headers, which may include the record headers 434, 436, 438, and 440 for corresponding portions of payload data of the records 402, 404, 406, and 408. In this example, the record header 440 is associated with a partial portion of payload data of the record 408 due to the size limitation of the data sector 412. In implementations, the storage engine 310 may then locate the group of record headers in the memory associated with the storage engine 310 based on the index entry that is retrieved or obtained from the entry list.

In implementations, after locating the group of record headers in the memory associated with the storage engine 310 (for example, based on information of a storage address included in the entry list), the storage engine 310 may transfer or send the group of record headers to the storage device 204, to cause the storage device 204 to write or store the group of record headers consecutively in a corresponding data sector of the storage device 204. In implementations, the storage engine 310 may transfer or send the group of record headers to the storage device 204 as a single group or via a single data transfer between the storage engine 310 and the storage device 204. In implementations, the storage engine 310 or the storage device 204 may write or store the group of record headers at the beginning part of the data sector. Continuing the above example as shown in FIG. 4, the storage engine 310 may send the record headers 434, 436, 438, and 440 as a single group or via a single data transfer to the storage device, to cause the storage device to store the record headers 434, 436, 438, and 440 consecutively in the data sector 412 of the storage device.

At block 508, the storage engine 310 may transfer or send a subset of payload data of one or more records associated with the group of record headers to the storage device to cause the storage device to store the one or more records after the group of record headers in the data sector of the storage device.

In implementations, the storage engine 310 may further locate corresponding portions of payload data of one or more records associated with the group of record headers based at least in part on the entry list. In implementations, the storage engine 310 may read the entry list to retrieve or obtain respective index entries that store or point to storage addresses of the corresponding portions of payload data of the one or more records. In implementations, these index entries may be located immediately after the index entry corresponding to the group of record headers in the entry list. For example, in the example as shown in FIG. 4, the index entries 418, 420, 422, and 424 store or point to the start storage locations of the corresponding portions of payload data of the records 402, 404, 406, and 408 that are currently stored in the memory associated with the storage engine 310. In the example as shown in FIG. 4, the corresponding portion of payload data of the record 408 is only a partial portion of payload data of the record 408 as described in the foregoing description.

In implementations, after locating the corresponding portions of payload data of the one or more records, the storage engine 310 may transfer or send the corresponding portions of payload data of the one or more records to the storage device 204 to enable or cause the storage device 204 to write or store the corresponding portions of payload data of the one or more records in the same data sector that stores the group of record headers. In implementations, the storage engine 310 or the storage device 204 may write or store the corresponding portions of payload data of the one or more records at a storage position immediately after the group of record headers in the data sector. In implementations, the storage engine 310 or the storage device 204 may further write or add a pointer that stores or indicates a start address or a start offset of a first record of the one or more records (or a corresponding portion of payload data of the first record) in a sector metadata area (or called as an out-of-band (OOF) area) of the data sector. For example, in the example as shown in FIG. 4, a sector metadata area 446 of the data sector 412 may include a pointer that stores or indicates a start address or a start offset of the payload data of the record 402 (i.e., the first record among the records 402, 404, 406, and 408) in the data sector 412.

In implementations, the storage engine 310 may continue to transfer or send any remaining record(s) and any remaining record header(s) to the storage device 204 according to the operations of the method blocks 506 and 508 as described above, to cause the storage device 204 to write or store the remaining record(s) and the remaining record header(s) into another data sector of the storage device 204 similarly using the operations as described in the foregoing description. For example, in the example as shown in FIG. 4, the storage engine 310 or the storage device 204 writes or stores the record header 442 at the beginning part of the data sector 414, and write or store the remaining portion of payload data of the record 408 and the entire portion of payload data of the record 410 immediately after the record header 442 in the data sector 414. Furthermore, the storage engine 310 or the storage device 204 writes or stores additional padding data 448 obtained from the padding data buffer 444 immediately after the payload data of the record 410 at the end of the data sector 414. Moreover, the storage engine 310 or the storage device 204 further writes or stores a pointer that stores or indicates a start address or a start offset of a first record (i.e., the record 410 in this case) in a sector metadata area 450 of the data sector 414.

In implementations, the storage engine 310 may further delete the plurality of record headers from the memory associated with the storage engine 310 after the plurality of record headers and the plurality of records are transferred or sent to the storage device, and are successfully written or stored in the storage device 204. In implementations, the storage engine 310 may further delete the entry list including the plurality of index entries corresponding to the plurality of record headers and the plurality of records, or clear the entry list to remove the plurality of index entries corresponding to the plurality of record headers and the plurality of records.

Referring back to FIG. 6, at block 602, the storage device 204 may receive a group of record headers associated with one or more records from the storage engine 310.

In implementations, the storage device 204 may receive an instruction from the storage engine 310 to write or store data. In implementations, the storage device 204 may receive a group of record headers from a storage engine 310 via one data access or transfer between the storage engine 310 and the storage device 104. In implementations, the group of record headers may include one or more record headers (such as at least two record headers, etc.) for corresponding portions of payload data of one or more records.

At block 604, the storage device 204 may consecutively store the group of record headers from a designated part of a data sector of the storage device 204.

In implementations, in response to receiving the group of record headers from the storage engine 310, the storage device 204 may write or store the group of record headers into a data sector. In implementations, the storage device 204 may consecutively write or store each record header of the group of record headers at a designated part of the data sector, such as at the beginning part of the data sector. In implementations, if there exists payload data of any new record is written or stored in the data sector, the storage device 204 may ensure that a record header corresponding to that payload data of the new record is written or stored at the designated part (such as the beginning part) of the data sector. Otherwise, the storage device 204 may allow or open the designated part (such as the beginning part) of the data sector to write or store other data, such as a remaining portion of payload data of a record of which some portion of payload data has been stored in another data sector. In implementations, the storage engine 310 or the storage device 204 may have previously selected or determined one or more data sector including the data sector for writing or storing the data received from the storage engine 310.

At block 606, the storage device 204 may receive payload data of one or more records from the storage engine 310.

In implementations, after successfully writing or storing the group of record headers, the storage device 204 may further receive the corresponding portions of payload data of the one or more records that are associated with the group of record headers from the storage engine 310.

At block 608, the storage device 204 may store the one or more records starting from a storage location that is adjacent to and immediately after the group of record headers in the data sector of the storage device 204.

In implementations, after receiving the corresponding portions of payload data of the one or more records that are associated with the group of record headers from the storage engine 310, the storage device 204 may write or store the corresponding portions of payload data of the one or more records that are associated with the group of record headers in the same data sector that stores the group of record headers. In implementations, the storage device 204 may write or store the corresponding portions of payload data of the one or more records at a storage location that is adjacent to and immediately after the end of the group of record headers in the data sector of the storage device 204.

In implementations, the storage device 204 may further store a start offset of a first record among the one or more records that are stored in the data sector at a special area (such as a sector metadata area or a OOB area as described in the foregoing description) of the data sector.

In some instances, the storage device 204 may further receive additional one or more record headers associated with additional one or more records from the storage engine 310, and may then write or store the additional one or more record headers at a designated part (such as a beginning part, for example) of a data sector that is adjacent to and immediately follows after the data sector that stores the one or more records associated with the group of record headers. In implementations, the storage device 204 may further receive the additional one or more records from the storage engine 310, and store the additional one or more records after the additional one or more record headers in the data sector that stores the additional one or more record headers. In implementations, depending on whether padding data is needed for block alignment of the data sector, the storage device 204 may or may not receive padding data from the storage engine 310. In an event that padding data is received from the storage engine 310, the storage device 204 may write or store the padding data at a storage location that is adjacent to and immediately follows after the additional one or more records in the data sector that stores the additional one or more records. In implementations, the storage device 204 may further store a start offset of a first record of the additional one or more records at a special area (such as a sector metadata area or an OOB area) of the data sector that stores the additional one or more records.

Referring back to FIG. 7, at block 702, the storage engine 310 may receive an instruction or request to obtain a record from a client device.

In implementations, the storage engine 310 may receive an instruction or request from a client device (such as the client device 208) to obtain a record through a network (such as the network 206). In implementations, the instruction or request from the client device 208 may include identifying information of the record, such as one or more criteria or conditions for selecting or determining the record, a filename of the record, address information of the record, etc.

At block 704, the storage engine 310 may obtain a portion of data that includes a plurality of consecutive record headers from a data sector that includes the record to be obtained in a storage device.

In implementations, in response to receiving the instruction or request from the client device 208, the storage engine 310 may determine a data sector of a storage device in which the requested record (i.e., the record to be obtained) is stored. In implementations, based on the identifying information of the record (the one or more criteria or conditions for selecting or determining the record, the filename of the record, or the address information of the record, etc.) included in the instruction or request, the storage engine 310 may determine or locate a storage device (such as the storage device 204) and a corresponding data sector in which the record is stored. In implementations, the storage engine 310 may first retrieve or obtain a portion of data including a plurality of consecutive record headers from the data sector that includes the record to be obtained in the storage device 204.

At block 706, the storage engine 310 may select a record header corresponding to the record to be obtained from the plurality of consecutive record headers.

In implementations, the storage engine 310 may further select or find the record header corresponding to the record to be obtained from the plurality of consecutive record headers based on the identifying information of the record to be obtained.

At block 708, the storage engine 310 may obtain the record to be obtained from the sector based at least in part on a record size included in the record header corresponding to the record to be obtained.

In implementations, the storage engine 310 may obtain metadata from a special area (such as a sector metadata area or an OOB area) of the data sector of the storage device 204. In implementations, the metadata may include at least a start offset of a first record in the data sector. In implementations, beginning from the start offset of the first record in the data sector, the storage engine 310 may read an amount of data equal to the record size if the record to be obtained is the first record.

Alternatively, if the record to be obtained is not the first record, the storage engine 310 may obtain one or more record headers before the record header corresponding to the record to be obtained, and calculate a start offset of the record to be obtained in the sector based on a sum of the start offset of the first record and respective one or more record sizes included in the one or more record headers. In implementations, beginning from the calculated start offset of the record to be obtained in the data sector, the storage engine 310 may then read an amount of data equal to the record size included in the record header corresponding to the record to be obtained.

In implementations, the record to be obtained may include multiple records to be obtained. For example, the multiple records may be stored in the same data sector or stored in data sectors that are physically or logically adjacent or neighboring to each other. The storage engine 310 may successively obtain the multiple records by performing the operations of the above method, or by performing the method blocks 706 and 708 if the consecutive record headers obtained at the method block 704 already include corresponding record headers of the multiple records.

Any of the acts of any of the methods described herein may be implemented at least partially by a processor or other electronic device based on instructions that are stored on one or more computer-readable media. By way of example and not limitation, any of the acts of any of the methods described herein may be implemented under control of one or more processors configured with executable instructions that may be stored on one or more computer-readable media.

### CONCLUSION

Although implementations have been described in language specific to structural features and/or methodological acts, it is to be understood that the claims are not necessarily limited to the specific features or acts described. Rather, the specific features and acts are disclosed as exemplary forms of implementing the claimed subject matter. Additionally or alternatively, some or all of the operations may be implemented by one or more ASICS, FPGAs, or other hardware.

The present disclosure can be further understood using the following clauses.

Clause 1: A method implemented by one or more processors of a storage engine, the method comprising: receiving data including a plurality of records from a client device; generating a plurality of record headers for the plurality of records; sending a group of record headers of the plurality of record headers to a storage device to cause the storage device to store the group of record headers consecutively in a data sector of the storage device; and sending a subset of payload data of one or more records associated with the group of record headers to the storage device to cause the storage device to store the one or more records after the group of record headers in the data sector of the storage device.

Clause 2: The method of Clause 1, wherein sending the group of record headers of the plurality of record headers to the storage device to cause the storage device to store the group of record headers consecutively in the data sector of the storage device is performed through a single data transfer between the storage engine and the storage device.

Clause 3: The method of Clause 1, further comprising storing the plurality of record headers and the plurality of records in a memory of the storage engine.

Clause 4: The method of Clause 3, further comprising: creating a scatter-gather list including a plurality of entries for the plurality of record headers and the plurality of records; and storing the scatter-gather list in a memory of the storage engine.

Clause 5: The method of Clause 4, further comprising: locating the group of record headers in the memory of the storage engine based at least in part on the scatter-gather list prior to sending the group of record headers to the storage device; and locating the one or more records in the memory of the storage engine based at least in part on the scatter-gather list prior to sending the one or more records to the storage device.

Clause 6: The method of Clause 5, wherein the plurality of record headers and the plurality of records are stored in one or more sectors of the storage device, and the scatter-gather list further comprises an entry including a start address of a padding data buffer configured to provide padding data for logical block alignment at an end of a last sector of the one or more sectors of the storage device.

Clause 7: The method of Clause 1, wherein generating the plurality of record headers for the plurality of records is performed after receiving the data including the plurality of records from the client device.

Clause 8: The method of Clause 1, further comprising temporarily storing the plurality of record headers consecutively in a memory of the storage engine before each of the plurality of record headers is sent to the storage device and is successfully stored in the storage device.

Clause 9: The method of Clause 8, further comprising deleting the plurality of record headers from the memory of the storage engine after each of the plurality of record headers is sent to the storage device and is successfully stored in the storage device.

Clause 10: One or more processor readable media storing executable instructions that, when executed by one or more processors of a storage device, cause the one or more processors to perform acts comprising: receiving a plurality of record headers associated with a plurality of records from a storage engine; consecutively storing the plurality of record headers from a beginning part of a sector of the storage device; receiving the plurality of records from the storage engine; and storing the plurality of records after the plurality of record headers in the sector of the storage device.

Clause 11: The one or more processor readable media of Clause 10, the acts further comprising storing a start offset of a first record among the plurality of records that are stored in the sector at a special area of the sector.

Clause 12: The one or more processor readable media of Clause 10, the acts further comprising: receiving additional one or more record headers associated with additional one or more records from the storage engine; and storing the additional one or more record headers at a beginning part of a sector that immediately follows the sector storing the plurality of records.

Clause 13: The one or more processor readable media of Clause 12, the acts further comprising: receiving the additional one or more records from the storage engine; and storing the additional one or more records after the additional one or more record headers in the sector that immediately follows the sector storing the plurality of records.

Clause 14: The one or more processor readable media of Clause 13, the acts further comprising storing a start offset of a first record of the additional one or more records at a special area of the sector that immediately follows the sector storing the plurality of records.

Clause 15: The one or more processor readable media of Clause 13, the acts further comprising: receiving padding data from the storage engine; and storing the padding data after the additional one or more records in the sector that immediately follows the sector storing the plurality of records.

Clause 16: The one or more processor readable media of Clause 10, wherein the plurality of record headers associated with the plurality of records is received from the storage engine through a single data transfer between the storage engine and the storage device.

Clause 17: A storage engine comprising: one or more processors; and memory storing executable instructions that, when executed by the one or more processors, cause the one or more processors to perform acts comprising: obtaining a portion of data including a plurality of consecutive record headers from a beginning part of a sector that includes a record to be obtained from a storage device; selecting a record header corresponding to the record to be obtained from the plurality of consecutive record headers; and obtaining the record to be obtained from the sector based at least in part on a record size included in the record header corresponding to the record to be obtained.

Clause 18: The storage engine of Clause 17, wherein obtaining the record to be obtained from the sector comprises: obtaining metadata from the sector of the storage device, the metadata including a start offset of a first record in the sector; and beginning from the start offset of the first record in the sector, reading an amount of data equal to the record size if the record to be obtained is the first record.

Clause 19: The storage engine of Clause 17, wherein obtaining the record to be obtained from the sector comprises: obtaining metadata from the sector of the storage device, the metadata including a start offset of a first record stored in the sector; obtaining one or more record headers before the record header corresponding to the record to be obtained; calculating a start offset of the record to be obtained in the sector based on a sum of the start offset of the first record and respective one or more record sizes included in the one or more record headers; and beginning from the start offset of the record to be obtained in the sector, reading an amount of data equal to the record size included in the record header corresponding to the record to be obtained.

Clause 20: The storage engine of Clause 17, wherein selecting the record header corresponding to the record to be obtained from the plurality of consecutive record headers comprises finding the record header corresponding to the record to be obtained from the plurality of consecutive record headers based on identifying information of the record to be obtained.

What is claimed is:

1. A method implemented by one or more processors of a storage engine, the method comprising:
receiving data including a plurality of records from a client device;
generating a plurality of record headers for the plurality of records;
sending a group of record headers of the plurality of record headers to a storage device to cause the storage device to store the group of record headers consecutively in a data sector of the storage device; and
sending a subset of payload data of one or more records associated with the group of record headers to the storage device to cause the storage device to store the one or more records after the group of record headers in the data sector of the storage device.

2. The method of claim 1, wherein sending the group of record headers of the plurality of record headers to the storage device to cause the storage device to store the group of record headers consecutively in the data sector of the storage device is performed through a single data transfer between the storage engine and the storage device.

3. The method of claim 1, further comprising storing the plurality of record headers and the plurality of records in a memory of the storage engine.

4. The method of claim 3, further comprising:
creating a scatter-gather list including a plurality of entries for the plurality of record headers and the plurality of records; and
storing the scatter-gather list in a memory of the storage engine.

5. The method of claim 4, further comprising:
locating the group of record headers in the memory of the storage engine based at least in part on the scatter-gather list prior to sending the group of record headers to the storage device; and
locating the one or more records in the memory of the storage engine based at least in part on the scatter-gather list prior to sending the one or more records to the storage device.

6. The method of claim 5, wherein the plurality of record headers and the plurality of records are stored in one or more sectors of the storage device, and the scatter-gather list further comprises an entry including a start address of a padding data buffer configured to provide padding data for logical block alignment at an end of a last sector of the one or more sectors of the storage device.

7. The method of claim 1, wherein generating the plurality of record headers for the plurality of records is performed after receiving the data including the plurality of records from the client device.

8. The method of claim 1, further comprising temporarily storing the plurality of record headers consecutively in a memory of the storage engine before each of the plurality of record headers is sent to the storage device and is successfully stored in the storage device.

9. The method of claim 8, further comprising deleting the plurality of record headers from the memory of the storage engine after each of the plurality of record headers is sent to the storage device and is successfully stored in the storage device.

10. One or more processor readable media storing executable instructions that, when executed by one or more processors of a storage device, cause the one or more processors to perform acts comprising:
receiving a plurality of record headers associated with a plurality of records from a storage engine;
consecutively storing the plurality of record headers from a beginning part of a sector of the storage device;
receiving the plurality of records from the storage engine; and
storing the plurality of records after the plurality of record headers in the sector of the storage device.

11. The one or more processor readable media of claim 10, the acts further comprising storing a start offset of a first record among the plurality of records that are stored in the sector at a special area of the sector.

12. The one or more processor readable media of claim 10, the acts further comprising:
receiving additional one or more record headers associated with additional one or more records from the storage engine; and
storing the additional one or more record headers at a beginning part of a sector that immediately follows the sector storing the plurality of records.

13. The one or more processor readable media of claim 12, the acts further comprising:
receiving the additional one or more records from the storage engine; and
storing the additional one or more records after the additional one or more record headers in the sector that immediately follows the sector storing the plurality of records.

14. The one or more processor readable media of claim 13, the acts further comprising storing a start offset of a first record of the additional one or more records at a special area of the sector that immediately follows the sector storing the plurality of records.

15. The one or more processor readable media of claim 13, the acts further comprising:
receiving padding data from the storage engine; and
storing the padding data after the additional one or more records in the sector that immediately follows the sector storing the plurality of records.

16. The one or more processor readable media of claim 10, wherein the plurality of record headers associated with the plurality of records is received from the storage engine through a single data transfer between the storage engine and the storage device.

17. A storage engine comprising:
one or more processors; and
memory storing executable instructions that, when executed by the one or more processors, cause the one or more processors to perform acts comprising:
obtaining a portion of data including a plurality of consecutive record headers from a beginning part of a sector that includes a record to be obtained in a storage device;
selecting a record header corresponding to the record to be obtained from the plurality of consecutive record headers; and
obtaining the record to be obtained from the sector based at least in part on a record size included in the record header corresponding to the record to be obtained.

18. The storage engine of claim 17, wherein obtaining the record to be obtained from the sector comprises:
obtaining metadata from the sector of the storage device, the metadata including a start offset of a first record in the sector; and
beginning from the start offset of the first record in the sector, reading an amount of data equal to the record size if the record to be obtained is the first record.

19. The storage engine of claim 17, wherein obtaining the record to be obtained from the sector comprises:
obtaining metadata from the sector of the storage device, the metadata including a start offset of a first record stored in the sector;
obtaining one or more record headers before the record header corresponding to the record to be obtained;
calculating a start offset of the record to be obtained in the sector based on a sum of the start offset of the first record and respective one or more record sizes included in the one or more record headers; and
beginning from the start offset of the record to be obtained in the sector, reading an amount of data equal to the record size included in the record header corresponding to the record to be obtained.

20. The storage engine of claim 17, wherein selecting the record header corresponding to the record to be obtained from the plurality of consecutive record headers comprises finding the record header corresponding to the record to be obtained from the plurality of consecutive record headers based on identifying information of the record to be obtained.
